(19) United States
(12) Patent Application Publication
(10) Pub. No.: US 2006/0181532 A1
(43) Pub. Date: Aug. 17, 2006

(54) Method and system for pixel based rendering of multi-lingual characters from a combination of glyphs

(75) Inventors: Vinjamuri Venkata Ravindra, Bangalore (IN); Vinjamuri Venkata Narasimha Rao, Bangalore (IN); Ramadevi Krishnan, Bangalore (IN)

Correspondence Address: BIRCH STEWART KOLASCH & BIRCH, PO BOX 747, FALLS CHURCH, VA, 22040-0747, US

(73) Assignee: Geneva Software Technologies Limited, Bangalore (IN)

(21) Appl. No.: 11/196,386

(22) Filed: Aug. 4, 2005

Related U.S. Application Data
(60) Provisional application No. 60/598,445, filed on Aug. 4, 2004.

(51) Int. Cl. G06T 11/00; G06F 17/30; G06F 3/00

(52) U.S. Cl. 345/467; 707/1; 715/764

(57) ABSTRACT

The present invention provides a method and system for dynamically rendering multi-lingual characters from a combination of pixels. The system of the present invention comprises, an input member, a database member, a processor and a display member. The user initially selects a language from a plurality of languages and further a character and/or modifier by means of an input member. The address location containing the character and/or character modifier profile generating executables is accessed and the corresponding character and/or character modifier profile generating executables is executed to generate a pixel sequence, which is associated with the shape of the character and/or character modifier. Subsequently the layout management tasks corresponding to the resultant character and/or character modifier is invoked from the database and executed. Finally the resultant character along with the fused modifier, wherever applicable, is displayed at the display member.

This Nonprovisional application claims priority under 35 U.S.C. §119(e) on U.S. Provisional Application No(s). 60/598,445 filed on Aug. 4, 2004, the entire contents of which are hereby incorporated by reference.

### FIELD OF INVENTION

The present invention relates generally to the field of natural language rendering. The present invention specifically relates to a method and a system for pixel-based dynamic rendering of multi-lingual characters of a language.

### BACKGROUND AND PRIOR ART

The language letter construction in English is fairly simple and straightforward, since any two consecutive letters are written next to each other without the need to “assemble them together”. Each glyph (or part of a letter) in English is a letter by itself. In other words, in English there are no “Matharas”. “Matharas” is an expression denoting bottom, top and side modifiers and stress and phonetic symbols of an alphabet) and vowel signs and there are no combinations of letters to form a single character and each letter is independent by itself. Whereas, in Indian language scripts, the assembly of characters is a must as many characters are a combination of glyphs. In Indian languages the number of glyphs to assemble a letter may vary from 1 to 6 glyphs.

The text processing systems in the modern computers and software use font systems in conjunction with coding standards like ASCII (American Standard for Information Interchange), ANSI (American National Standards Institute), ISFOC (Intelligence Based Script Font Code) and Unicode. Similarly, for Indian languages the coding standard is ISCII (Indian Standard Code for Information Interchange).

Unicode is a new and internationally standardized code encoding for character data that allows computers to exchange and process character data in any natural language text. The most common usage of Unicode is, in representing each character as a 16-bit number. Unicode has a language allocation table, which allocates code places for each language according to the space requirement of the language. Each language has a certain address and a certain number of allocated code places for characters. According to the language allocation table of Unicode, Indian language range commences with Devanagari script at address 0901 HEX and is allocated 128 code places. Similarly, other Indian languages including Bengali, Gurumukhi, Gujarati, Oriya, Tamil, Telugu, Kannada, and Malayalam are allocated 128 code places each. However, Unicode by itself it cannot render any language. Rendering involves outputting or displaying or printing on an output device which could be a display unit like a computer monitor or a printing unit like a printer. This rendering in case of Unicode has to be done with help of a local font. A local font is a font whose starting and ending addresses are matching with the starting and ending addresses of that particular language in the Unicode specifications. For example the typical local font for Kannada language will have a starting address as 0C82 HEX and ending address as 0CEF hex.

For transmission of Unicode from one system to another a local font is required in both the systems. The local font in both the systems has to be Unicode compatible else the receiving system will display junk data.

For Indian languages, Unicode provides only 128 code places per language. The requirement to accommodate the complete character range for an Indian language is about 600-700. The characters that are beyond the address range of 128 (according to the specifications of Unicode) will be parsed (or filtered) resulting in data-loss.

An access to http://www.unicode.org/charts/fonts.html has disclosed the following: The shapes of the reference glyphs used in these code charts are not prescriptive. Considerable variation is to be expected in actual fonts. The particular fonts used in these charts were provided to Unicode Consortium by a number of different font designers, who own the rights to the fonts.

The language construction in Indian languages is based on certain parameters. In Indian languages, the number of vowels is 15-20, vowel signs 15-20, consonants 30-50, Matharas (Bottom and top modifiers of an alphabet) 30-50, Special characters 5-10. For instance, Kannada, a South Indian language of the State of Karnataka in India, comprises the following language parameters:

Number of vowels 16

[symbol]

Number of vowel signs 18

[symbol]

Number of consonants 34

[symbol]

Number of Matharas 36

[symbol]

Number of Special Characters 6

The character set in an Indian language is also known as “Varnamala”. Therefore, in order to codify the above characters in Kannada, the total number of address places that is required for Kannada Vamamala (Kannada character set) is 612. (Combinations of a Consonant with a Vowel sign 18*34=612). Accordingly, the range of character sets that are required for Indian languages is 600-700. However,

Unicode provides only 128 spaces for the same.

There are some related prior art references in field of character generation. Some of the prior art patents are listed below.

U.S. Pat. No. 4,670,841, “Composite character generator” depicts a system for the generation of composite ideographic characters. Composite characters are generated by the placement of basic characters, which are stored in memory into basic layouts, which have at least two selection areas, which divide the display area of a display device. The basic layouts are generated by the selection of one of a plurality of basic layouts stored in memory. The basic characters are placed in a selection area of a basic layout by selection of one of a plurality of basic characters stored in memory.

Basic layouts may be nested within the active selection area of a current layout. Scaling of basic character size and location and basic layout size and location is accomplished by use of stored compression coefficients and the origin of each selection area of the basic layouts.

U.S. Pat. No. 4,723,217, “Apparatus for outputting a character composed of basic symbols” which depicts an apparatus for outputting a character composed of basic symbols such as a Korean character, said apparatus adjusts an outputted design or outputted design alteration. The apparatus includes an input device for inputting a plurality of binary codes, each binary code corresponding to a respective one of the basic symbols; an output device for outputting the character; a detecting circuit for detecting an indication code for supplying a space character from among the binary codes; a first calculating circuit for calculating the number of basic symbols; a converting circuit for converting the number of characters into a number of outputted units with respect to the size of the basic symbols; a second calculating circuit for calculating the supplying number of space characters by subtracting the number of outputted units from the number of basic symbols; and a supplying circuit for supplying a space character code to the output device, the number of space character codes being equivalent to the supplying number, the supplying circuit operated on or after an indication code has been detected by the detecting circuit. The limitation of the above patent is that it is confined to Korean language for sequencing basic symbols to output a character and these symbols have to be stored in the database.

U.S. Pat. No. 5,835,100, “Method and system for displaying characters composed of multiple juxtaposed images within a display device of a data processing system” depicts a system in which the character patterns of all kana (Japanese characters) or kanji (Chinese characters) to be displayed are divided substantially into halves in a horizontal direction (or alternately in a vertical direction) and stored in memory. Image codes corresponding to the divided character patterns thus obtained are assigned thereto, so that an image code is assigned to a corresponding portion of a kana or kanji. Accordingly, when the kana or kanji is displayed, the two image codes (character codes corresponding to the left and right sides of the same character) which are assigned to the above described character patterns are written to addresses of a buffer corresponding to the location on the screen the kana or kanji is to be displayed.

Thus, the two portions of the kanji to be displayed are displayed in adjacent areas on the screen of a display device.

The cited prior art references are suitable to ideographic-based languages like Chinese, Japanese and Korean. However, their application is limited to few of the Indian languages. Indian languages are not stroke based. Analogous to Ideographic scripts, Indian languages are based on “Brahmi Script”. Further, the above-mentioned prior art patents generally relate to stroke-based technology and are suitable for languages such as Chinese, Japanese and Korean.

A static rendering system uses a method of displaying a language character using a Font (a set of alphabets of a language). The font can be in the format of TTF (True Type Font). This is a straight forward method to display a language on a 1:1 basis, which means every character is mapped with a font number which will be either ASCII or UNICODE. This method is limited, since it needs the font to be available on the source and target environment. This method also needs a driving program to render the characters. The driving program will display appropriate font numbers based on the key input. If Unicode system is employed then a local font is necessary to render the characters. A local font is one whose starting address (the location from where the starting characters begin) coincides with the Unicode Language Identification.

### OBJECTS OF THE INVENTION

The primary object of the present invention is to provide a method for pixel-based dynamic rendering of Unicode compatible multi-lingual characters with a low transmission size.

An object of the present invention is to provide a method to use character and character modifiers for rendering multi-lingual character formation.

Yet another object of the present invention is to provide a method for rendering and displaying of Unicode compatible language characters.

Further object of the present invention is to provide a method wherein dots or pixels are used for rendering language processing and display in place of strokes.

It is also an object of the present invention is to provide a method that can work in tandem with Unicode for data transmission, without any data loss.

It is also an object of the present invention to provide a system that can implement a pixel-based dynamic rendering of Unicode compatible multi-lingual characters with a low transmission size.

### SUMMARY OF THE INVENTION

The present invention provides a method for dynamically rendering multi-lingual characters from a combination of pixels. Initially, a language and the desired character and/or modifier of the selected language is chosen by means of an input member. Upon selection of the character, the address location in a database containing the corresponding character and/or character modifier profile generating executables is accessed and the corresponding character and/or character modifier profile generating executables is executed to generate a pixel sequence, which is associated with the shape of the character and/or character modifier. Subsequently, the layout management tasks corresponding to the resultant character and/or character modifier are invoked from the database and executed. Finally, the resultant character along with the fused modifier, wherever applicable, is displayed on a display member. The present invention also provides a system for dynamically rendering multi-lingual characters from a combination of pixels, said system comprising an input member, a database member, a processor and a display member. The adoption of the system of the present invention provides a dynamic rendering of multi-lingual characters with a low data transmission size.

The above and other features/advantages of the invention will become more apparent from the following description and the accompanying drawings.

### BRIEF DESCRIPTION OF THE DIAGRAMS

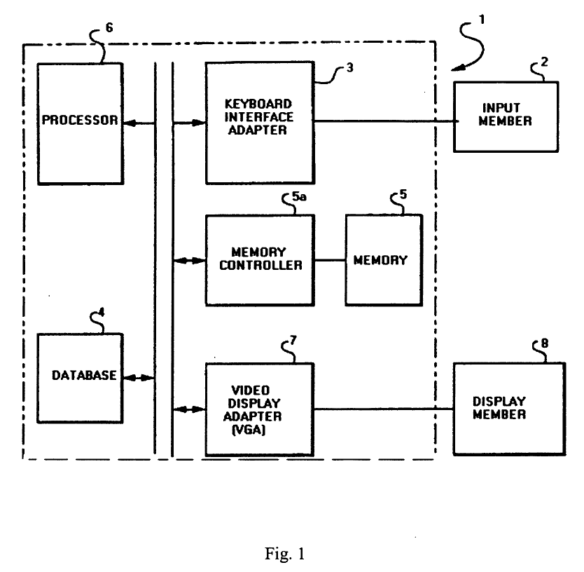

FIG. 1 depicts a block diagram of the system to render Unicode compatible languages.

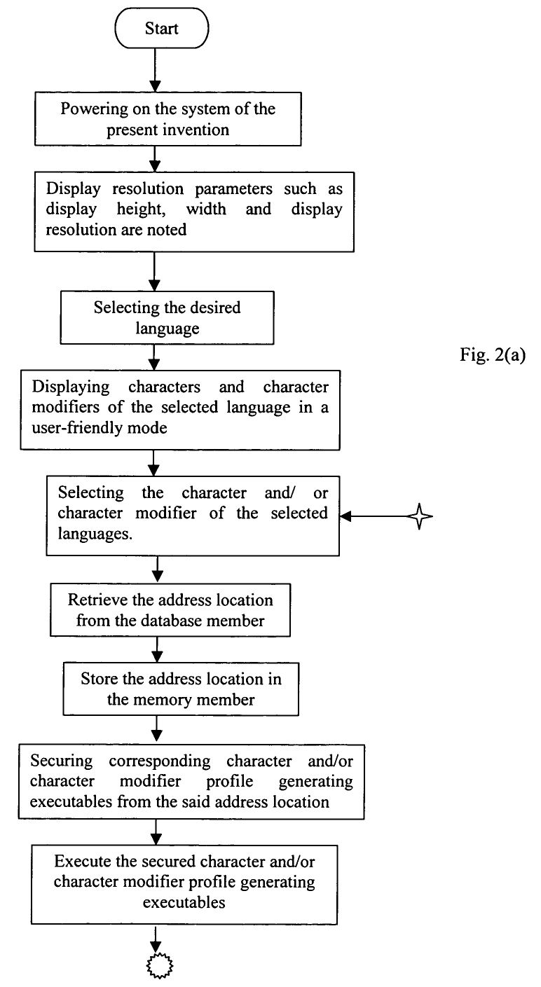

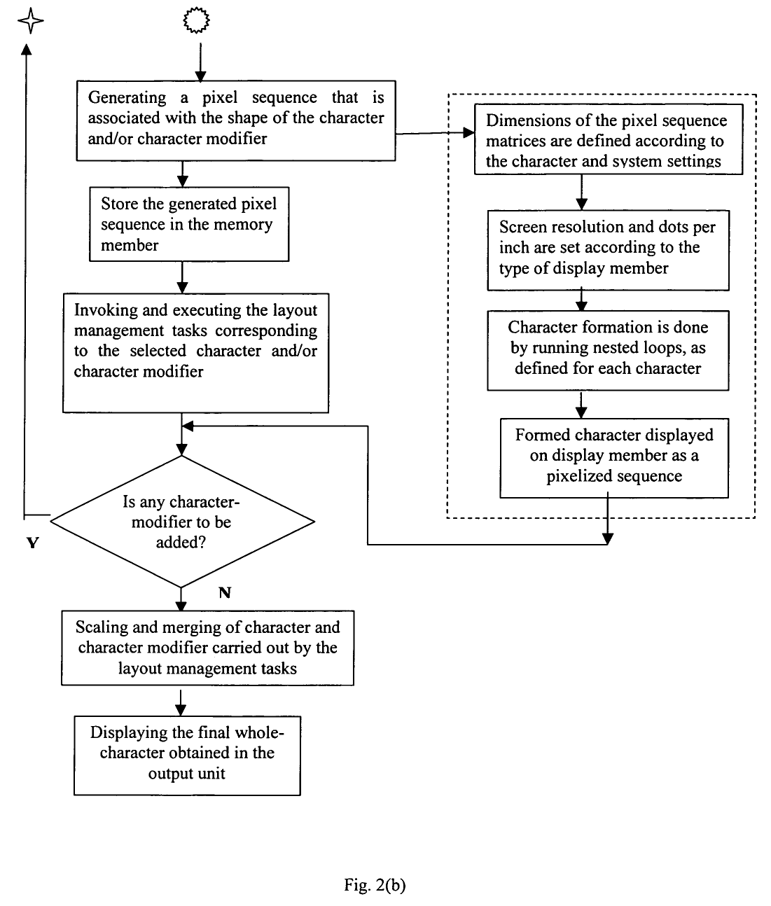

FIG. 2(a) and FIG. 2(b) are a flow diagram of the method of the present invention depicting the steps involved in the rendering of the Unicode compatible languages.

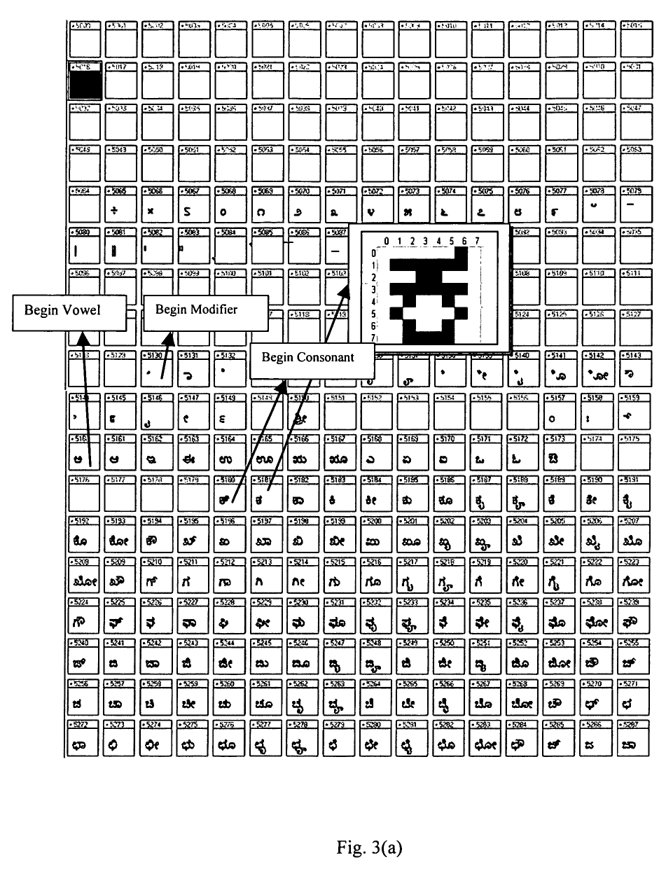

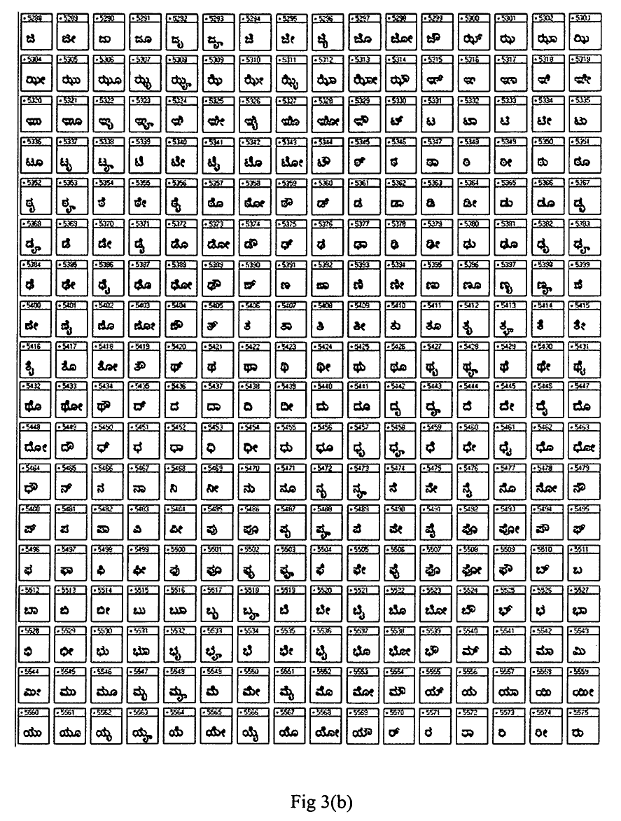

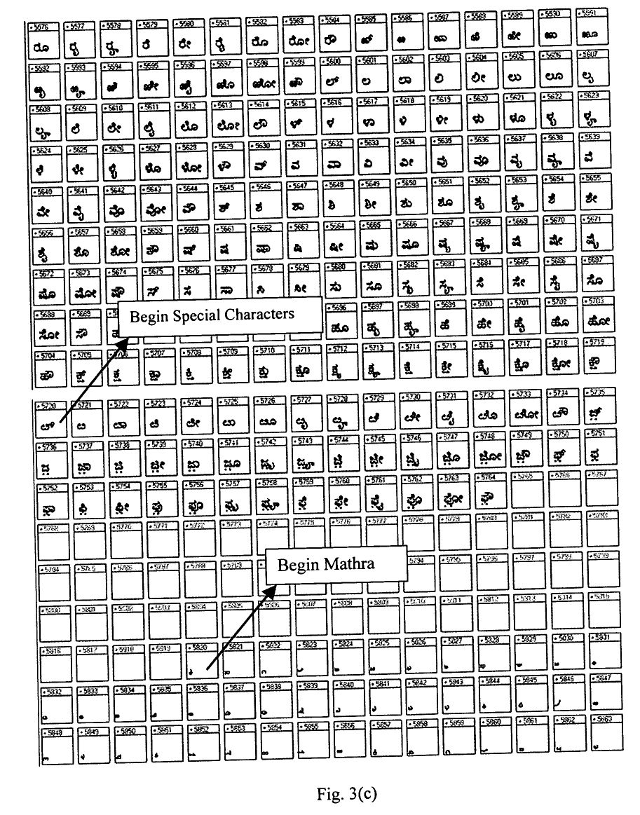

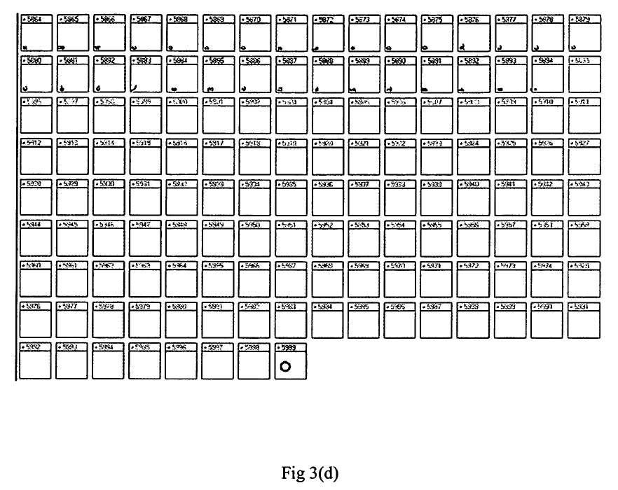

FIGS. 3(a), (b), (c) & (d) illustrate an exemplary embodiment of the present invention depicting the address locations allocated specifically for Kannada language and the specific character that each address generates.

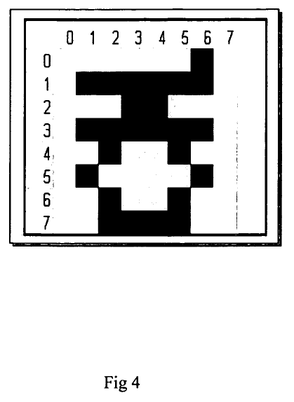

FIG. 4 depicts an exemplary embodiment of an alphabet in Kannada, an Indian language, in the form of a matrix formation or virtual image of a single character in Kannada language.

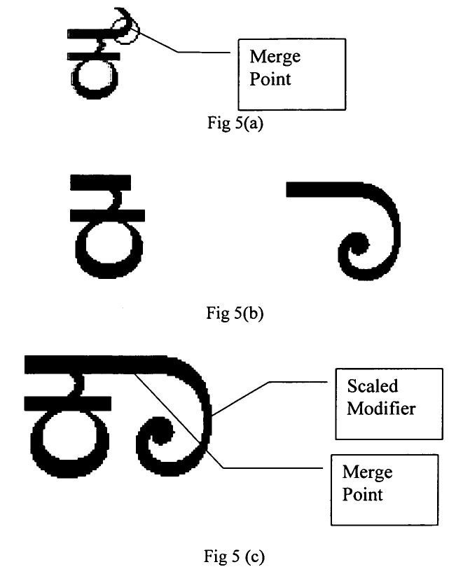

FIG. 5(a), FIG. 5(b), and FIG. 5(c) collectively depict an exemplary embodiment of an alphabet in Kannada, an Indian language, in the form of various stages involved in the formation of a whole-matrix of whole character derived from a combination of a single character and a character-modifier.

### DETAILED DESCRIPTION OF THE INVENTION

Accordingly, the present invention provides a method for dynamically rendering multi-lingual characters from a combination of pixels. The embodiments of the present invention are explained by initially referring to FIG. 1 of the accompanied diagrams. An input member (2), such as a keyboard of a PC/Server, a touch screen input from a PC/Server, Stylus input from a PC/Server, Keypad input from a PDA, stylus input from a PDA, keypad input from a Cellular phone or a stylus input from a cellular phone is used to select the desired language and characters. The input member is used to generate a binary code corresponding to each of the character or character modifier and an indication code for supplying a space character. A keyboard interface adapter (3), to act an interface between the input member (2) and other associated components of the system. The input member (2) of the system (1) of the present invention facilitates a user to select a desired language, from a range of languages, preferably Unicode compatible languages from the list of languages that are made available to the system of the present invention. The input member (2) also facilitates in the selection of desired character or character modifier by the user through the input member (2). The display format of the system of the present invention for the input member (2) is by way of a display menu, preferably a prompting menu to define a user-friendly mode, said menu having an arrangement of deck of characters and character modifiers. Further, the display format is also arranged to provide a selection of characters or character modifiers from the display menu either individually or by way of scrolling.

A memory member (5) disposed to provide storage cum work area for implementing the system of the present invention is a memory member that is generally used in implementing applications of this nature in digital machines, such as RAM or Cache memory. A memory controller (5a) is connected to the memory member (5). A database member (4) is used to store the basic executable modules of selected languages to generate the images of the characters. The database member (4) comprises address locations of executable modules corresponding to characters and character-modifiers including top, bottom and side modifiers, special characters & numerals of the selected language. Further, the database member (4) also comprises address locations of executable modules of resultant characters that are formed out of combination of characters and modifiers of the selected language.

The languages that are implemented by the system of the present invention are stored in the database member (4) and are retrieved on selection by the user. The database member (4) also stores the address locations having character and/or character modifier profile generating executables. The database member (4) comprises address locations of characters, character-modifiers including top, bottom and side modifiers, special characters & numerals of the selected language. Further, the database member (4) also comprises address locations of whole-characters that are formed out of combination of characters and modifiers of the selected language. For each of the above, corresponding profile generating executables are stored in the corresponding address locations.

In addition, layout management tasks for each of the characters and/or character modifiers are also stored in the database member (4). The layout management tasks are unique for each of the characters and/or character modifiers. Basically, the data in the database member (4) is stored such that the address location, the character and/or character modifier profile generating executable and the layout management tasks for every character and/or character modifier is stored adjacent to each other for easy retrieval. This is easily accomplished by use of a 3-dimensional matrix structure for the database member (4). The storage of a typical alphabetical sequence in the database member for the alphabets of Kannada language is shown in a 3-dimensional structure, said 3-dimensional structure consisting of, address locations, character profile generating executables and layout management tasks. The 3-dimensional matrix structure has been depicted below by means of a pictorial representation.

[image]

The languages are stored in the database member (4), preferably in the form of a table, which comprises a range addresses to accommodate the character set of each of the Unicode compatible languages. A sample table (Table 1) is provided below showing the address locations that have been assigned to selected Indian languages to make it compatible with Unicode Standards. Similarly, the address locations are also assigned for other Unicode compatible languages such as Chinese, Japanese, Korean, Spanish etc.,

TABLE 1

| Sl. | Indian Language | Range of address spaces |
|---|---|---|
| 1 | Devanagari | 4000-5000 |
| 2 | Kannada | 5000-6000 |
| 3 | Telugu | 6000-7000 |
| 4 | Tamil | 7000-8000 |
| 5 | Malayalam | 8000-9000 |
| 6 | Oriya | 9000-10000 |
| 7 | Bengali | 10000-11000 |
| 8 | Gujarati | 11000-12000 |
| 9 | Punjabi | 12000-13000 |
| 10 | Sanskrit | 13000-14000 |
| 11 | Assamese | 14000-15000 |
| 12 | Urdu | 15000-16000 |

Indian languages Hindi and Marathi adopt an ancient Devanagari script, which is a common script for both the languages. Therefore, both these languages are included as a single entity under Devanagari script and as a result these two languages have been allotted address locations viz., 4000-5000. Consequently, the actual number of Indian languages that can be supported by the present invention is 14.

In addition to strong the address locations having character and/or character modifier profile generating executables, there are certain address locations which are kept empty in the database for scalability and addition of possible new characters to that languages in future.

In an exemplary embodiment, we refer to FIGS. 3a, 3b, 3c & 3d of the accompanied diagrams, wherein an allocation of address locations for an Indian Language—Kannada, which is the Official language of the State of Karnataka, India. A specific character and/or character modifier that is stored in the address location is depicted in the form of character images and/or character modifier image for sake of clarity. However, in reality the images of the characters or character modifiers are not stored, but instead executable modules of such specific character and/or character modifiers are stored.

When the specific character and/or character modifier is called, the corresponding character and/or character modifier profile generating executable is run and a character and/or character modifier matrix is generated which is unique to every character and/or character modifier.

For instance, in FIG. 3a, a single character in address location 5181 is shown in its matrix form (pixelized matrix). Similarly, all other characters and/or character modifiers also have their specific executable modules and their corresponding matrix forms. It may be note here that for sake of clarity all the characters and/or character modifiers have been depicted in their image forms and not depicted in their matrix forms.

In the present invention, as an exemplary embodiment, the address locations provided for the Kannada language is between 5000-6000. All the characters of the Kannada language have been defined within the above range of address places. FIG. 3 depicts the address places that have been allocated for each character of the Kannada language. As shown in FIG. 3, each address place is allocated for a single character. Each address place basically is a 16-bit (4 digit) number.

The vowels of the Kannada language are placed in the top row from address place commencing from 5160 and the consonant series starts from address place 5180. Consonants with modifiers are allocated from 5130. Address locations up to 5720 are allotted to other signs and special characters. Further, blank address locations are also allotted to provide scalability.

A processor (6) is used to provide processing of character formation tasks of the present invention, which is generally a microprocessor or a series of microprocessors Intel Series—80486, Pentium-I, II, III, IV, Centrino, AMD Series complete range, XSCALE Series, MCORE, Motorola chipset, Nokia chipset, ARM Series etc, that are suitable for language processing in digital computers and cellular devices. A display adapter (7) is connected to a display member (8), such as a digital LCD (Liquid Crystal Display), PDA and VDU (Visual Display Unit). The display adapter (7) is disposed to act as an interface between the system and the display member (8).

Each depression of the input member (2) is mapped with corresponding address locations in the database member (4). The mapping arrangement in the present invention is conventional one that is prevalent in digital systems. Each key of the input member (2) is mapped in the mapping table to correspond with a particular address of the address location in the database member (4). As soon as a particular key is depressed, a signal is communicated to the processor (6), which retrieves the corresponding address from the database member (4) shifts the same in the memory member (5). The memory member (5) of the present invention is a RAM or Cache depending on the system (1) used. The processor (6) of the present invention is selected from Microprocessors that suitable for language processing in digital computers and cellular devices.

The processor (6) on receipt of data from the input member (2) and memory member (5) secures the corresponding character and/or character modifier profile generating executables from the address location pointed out by the address stored in the memory member (5). Once the character and/or character modifier profile generating executables is secured by the processor (6), the same is stored in the memory member (5). The processor (6) finally generates a pixel sequence, which is associated with the shape of the character and/or character modifier. This generated pixel sequence is then stored in the memory member (4). This generated pixel sequence is in the form of a matrix with dots and spaces.

The processor (6) also is disposed in order to invoke the layout management tasks corresponding to the resultant character and/or character modifier from the database member (4). The processor finally executes the layout management tasks and displays the resultant character along with the fused character modifier, wherever applicable. The resultant character is displayed at a display member (8), which constitutes the output of the system. In case, a series of characters is selected by the user one after the other, the same procedure is repeated for a series of characters, and the resultant series of characters with fused modifiers is displayed at the display member (8).

The system (1) of the present invention can be implemented in any microprocessor-based systems like Personal Computers, Workstations, PDA or any another processing devices used to process and display language characters. The system of the present invention can also be implemented in mobile communication technology based devices or systems including cellular phones. The system of the present invention supports a plurality of Unicode compatible languages.

The embodiments of the present invention relating to the method of dynamically rendering character or character modifier is provided initially by referring to FIG. 2. When, the system of the present invention is powered on, corresponding initialization routines pertaining to environment settings are executed to seek basic display resolution parameters such as height, width and resolution (dots per inch). The height and width parameters signify the space available for the system to draw the selected character or character modifier on the display member (8). The display width and height are recorded by the processor (6) for use during the execution of layout management tasks. The resolution or dots per inch of the display member (4) is also recorded by the processor (6).

Now by referring to FIG. 2, a user initially selects a language followed by the selection of characters, which are to be displayed, from plurality of languages that are made available in the database member (4) of the system (1) of the present invention. On selection of the language by the user, the different characters of the language are displayed for selection by the user, in a very user-friendly mode.

The option of the characters and/or character modifier of the language, which is to be selected by the user is provided to the user in the form of a prompting menu-based language deck. The user-friendly mode is a menu-based deck of characters and/or character modifiers which is displayed at the bottom of the display member (8). The character and/or character modifier is selected either individually or by way of scrolling depending on the system configuration available with the user.

The user has to select the desired character from the list of characters displayed on the menu-based language deck in the display member (8). On depression of the desired character to be displayed by means of the input member (2), the keyboard interface adapter (3) interfaces the key-depression provided at the input member (2). Each depression of the input member (2) is mapped with corresponding address locations in the database member (4). The mapping arrangement in the present invention is conventional one that is prevalent in any digital processing systems. Each key of the input member (2) is mapped in the mapping table to correspond with a particular address of the address location in the database member (4). As soon as a particular key is depressed, a signal is communicated to the processor (6), which retrieves the corresponding address from the database member (4) shifts the same in the memory member (5).

For instance, if a user desires to display a character having a character-modifier combination, the flow of events is as follows:

For instance, in order to key in a Kannada alphabet [symbol] the user follows following set of instructions.

For the sake of this example, it is assumed that the type of selection of the characters available to the user is an individual selection or manual selection. The user initially depresses a key, depressing which the character set which he desires will appear. The keys are allotted according to the alphabet of the language or Varnamala. In the instant case, the character set for this key is retrieved by depressing the key “1”. When the key “1” is depressed the following language deck appears on the display for the perusal of the user.

[image]

Since the user desires to select a character [symbol] , which is the first character of the character set as shown in the above language deck, the corresponding key of the input member (2), (ie. key number 1) to select the desired character.

[image]

By selecting the key number, a process to display the first character of the selected character set of the language deck on the display member (4) is initiated.

When the user referring to the language deck selects a character, by means of the input member (2), mapping process is initiated and the selected character is mapped in the mapping table to correspond with a particular address of the address location in the database member (4).

No sooner than particular key is depressed (It may be noted here that depression of key includes other forms of inputs such as touch screen input, stylus input etc.,) a signal is communicated to the processor (6), which retrieves the corresponding address from the database member (4) shifts the same in the memory member (5). The appropriate address of the address location for the selected character that is fetched from the database member (4) is shifted to the memory member (5). Now, the memory member (5) is provided with the address of the selected character, whose corresponding address location resides in the database member (4). The address location of the database member (4) comprises corresponding character profile generating executables.

Once the relevant address is shifted to the memory member (5), the processor (6) secures the corresponding character generating executables from the address location pointed out by the address stored in the memory member (5). The secured character generating executables are also stored in the memory member (5) by the processor (6).

Once the character generating executable for the selected character is stored in the memory member (5), the processor (6) finally executes the character generating executables to generate a pixel sequence which is associated with the shape of the selected character. The generated pixel sequence is then stored in the memory member (5). The layout management tasks that are stored in the database member (4) are also retrieved by the processor (6) which are used to fine-tune the generated pixel sequence.

The functional steps of the character generating executables are as follows:
I. Reading Screen Resolution from environment settings
II. Picking up appropriate character matrix ratio, where matrix ratio depends on output unit. For instance, if the dots per inch (dpi) are 72 then pick 24×24 matrix ratio for the character.
III. Starting Global counter or character positioning counter ‘g’ with an initial value equal to 1, where “1” is the left coordinates of the output unit
IV. Starting Outer loop counter or pixel column counter from 0 to 23 (columns)
V. Starting inner loop counter or pixel row counter from 0 to 23 (rows)
VI. Reading row value and plot appropriate dots (pixels)
VII. Incrementing row counter value by 1
VIII. Ending the loop end—row
IX. Incrementing pixel column counter by 1
X. Ending the loop end—columns
XI. Incrementing global counter with the value of the width of the letter i.e., 24+space of 2

The character-generating executable takes the address location of the character as a pointer and the corresponding values for generating the character are computed.

The main parameters for computation are the environment settings, which include screen resolution in terms or the dots per inch and the extents of the screen expressed as “x” and “y” pixel values. Like 640×480, 1024×768. The pixel sequence that is generated is stored in the form of a matrix. The character matrix ratio is appropriately chosen from 12×12, 16×16, 24×24, etc. For environments like the PDA or Mobile, the display system will be unique or proprietary to OEMs (Original Equipment Manufacturers). The ratio of the matrix will be chosen as 17×24 etc.

Once these parameters are in place, the character-generating executable begins with a global counter, which stores the cursor position relative to the width of the character. Initially this counter is set to the leftmost position of the display member. The display left position is the x-axis position of the first available pixel on a display. Next the counters for incrementing the rows and columns are started. The initial values will be ‘0’ for both and the ending limit will be the ratio value (like 23 for a 24×24 ratio).

The row value is read from the string expression, which returns the pixels to be darkened (whose value is to be set for ‘1’). Each element of the row is incremented until the last pixel of the row limit is reached. The row counter governs this. When the first row is complete, the column counter is incremented by ‘1’; the routine is repeated for all the rows until the column limit is attained. After the character is fully formed, the global counter is updated with the width of the formed letter and additional count of 2 is added to provide the placeholder for the cursor.

The output will be returned as a string with pixel information for a 12×12, 16×16 or a 24×24 ratio matrix.

After the address of a character to be formed is computed, then the executable to be applied is for the character formation. The executable compute the following:

Character Base Height:

Depending on the platform like a PC (Personal Computer), PDA (Personal Digital Assistant) or Cellular Phone, the minimum size of Indian language letter will be about 14 to 18 points depending on the language.

For a resolution of 79×81 dots per inch, the width is about 10 pixels and the character height is about 14 pixels

The higher the dots per inch the number of corresponding pixels will be more. For instance, in a PC environment, the difference in Picture quality on a 640×480 pixels and 800×600 pixels is because of the size of the pixel. Higher the resolutions smaller will be the pixel size

This setting is automatically calculated by the layout manager depending on the environment and display settings.

Character Matrix Ratio:

Based on the display settings and permissible client width of an environment the character matrix ratio has to be adjusted. Client width signifies the space available for the program to draw on the screen.

[image]

The above figure shows the display of a typical cellular phone. The Client area will be smaller than the actual area of the display. This is the first factor of measurement. The second factor of measurement is the availability of “number of lines” and “number of characters per line”. On a typical cellular phone, 3-5 lines are supported with about 20 characters per line. This will be smaller for older phones and for the advanced phones the number of lines will extend. However in this case the Standard SMS (Short Messaging Service) protocol limits the message width to 160 characters.

Based on these parameters, the character matrix is calculated. The possible combinations are:

12×12

16×16

24×24

17×24

All the values are in pixels

Actual Character Data

The actual data about a character is stored in the form of a character-generating executable. The matrix is generated when the character is selected by the user and the address location for that character is secured and the data in the address location, which basically is a character generating executable to that character, is finally executed. A typical pixelized matrix representation of a character will be in the ratio as described above. A depiction of the matrix for the character [symbol] is shown in FIG. 4.

In FIG. 4, the digital areas of matrix of a character to be displayed are categorized into display and non-display areas. The displayed pixels are marked as dots, which carry the pixel information as “1” and non-displayed pixels are blank are null or “0” respectively.

This matrix is read by appropriate functions and the output is sent to the Operating System specific output unit (8). The result is the display of the character on the PC Screen or a PDA or on a Cellular Phone as an Image.

Once the character image is generated as specified above, display of the character is performed in conjunction with Unicode Standards (UTF-8).

In order to illustrate the formation of the pixel sequence, we consider an exemplary embodiment. For instance, if the pixel sequence has to be generated for a character

[symbol]

The pixel sequence generation formation detail for the above character is represented below in the form of Binary data or HEX data.

[image]

The above figure represents the pixel sequence generation details of the above character. The ratio of formation is 8×8 pixels.

In order to generate the above pixel sequence, the following steps are adopted:
1. Reading screen resolution from environment settings
2. Picking up appropriate character matrix ratio, where matrix ratio depends on output unit. For instance, consider 8×8 matrix ratio for the character.
3. Starting Global counter ‘g’ with an initial value equal to 1, where “1” is the left coordinates of the output unit
4. Staring Outer loop counter from 0 to 7 (columns)
5. Starting inner loop counter from 0 to 7 (rows)
6. Reading row value and plot appropriate dots (pixels)
7. Incrementing row by 1
8. Ending loop—row
9. Incrementing column by 1
10. Ending loop end—columns
11. Incrementing global counter with the value of the width of the letter i.e., 8+space of 2 (determined by Layout Manager)

Some of the important stages of the formation of the above pixelized image are provided below:

Stage 1

Filling of the pixels begins in Row-1 and continues till the end of the Row. The formed picture would look as below:

[image]

Stage-2

Filling of the pixels begins in Row-2 and continues till the end of the Row. The formed picture would look as below:

[image]

Stage-3

Filling of the pixels begins in Row-5 and continues till the end of the Row. The formed picture would look as below:

[image]

Stage-4

Filling of the pixels begins in Row-6 and continues till the end of the Row. The formed picture would look as below:

[image]

Stage-5

Filling of the pixels begins in Row-7 and continues till the end of the Row. The formed picture would look as below:

[image]

This is the completed pixel sequence of the character

[symbol]

The generated pixel sequence is associated with the shape of the character and/or character modifier from the database member (4).

The formation of character modifiers and their linking to the selected character is explained by referring to FIG. 5(c).

In the present invention, the desired modifiers are welded to the characters before merger and display. For instance, if a single character is keyed the same is displayed on the display member (8). However, if the user desires to add character-modifiers to the above displayed character, a suitable key of a modifier is depressed to generate the desired character-modifier at the display member (8) and said modifier is positioned at a pre-determined place near placed the selected character. The placement of the character-modifier is decided in accordance with the layout management tasks stored in the database member (4). Once the character and the character-modifiers are placed close to each other, the modifiers are combined or merged to form a single unit.

After the generation of the pixel sequence by the processor, the generated pixel sequence is stored in the memory member (5). The processor (6) then invokes the layout management tasks corresponding to the resultant character from the database member (4). The layout management tasks are divided into three main tasks, which are scaling height and width of character to be displayed, fusing or merging the scaled character with the scaled modifier and also determining the space between any two resultant characters.

The processor (6) then finally executes the layout management tasks that were invoked from the database member (4). During the process of execution of the layout management tasks, initially the scaling of the height and the width of the generated pixel sequence of the character is performed. For determining the scale height and width of the pixel sequence of the character, the recorded data, which was initially stored in the memory during the power-on of the system, is used. Accordingly, the scaling of the height and the width of the desired character is performed as per the dimensions of the display member (4) of the system (1) as well as considering the dots per inch or resolution of the display member (4).

In case the user desires to have a character modifier also in addition to the character already selected, then the above steps of selection of the desired character modifier, fetching of appropriate address location, shifting the address of address location to memory, securing and executing the corresponding character modifier profile generating executables, invoking and executing the layout management tasks are repeated again for the character modifier.

When the user also selects a character modifier, the scaling step of the layout management tasks also involves adjustment of the height and width of the character modifier. The character and the character modifier are scaled or trimmed to the extent required. The different steps involved in scaling and merging of the character and character modifier are depicted in FIG. 5. Once the character and the character modifier are scaled to the desired requirement, then scaled character and scaled character modifier are merged together at the merge point, as depicted in FIG. 5(c).

In another embodiment of present invention, the dynamic rendering of characters does not depend upon the fonts or Unicode. This dynamic rendering of characters is achieved by use of character profile generating executables to create the language characters dynamically. Dynamic rendering uses the mechanism of pixels, strokes, glyphs to produce the shape of the characters on the display member (4).

The process of merging of character-modifiers with the character is depicted in the form of following examples.

### EXAMPLE 1

The steps involved in the merging process of the character [symbol] is graphically represented as follows:

[image]

In this example, a combination of character modifier with the corresponding character and their respective address locations are shown. On depression of consonant, the consonant is displayed and thereafter the desired character modifier is selected. The character and character modifier are merged to form a resultant character along with fused modifiers. [symbol]
+ [symbol] =

[symbol]

The phonetic representations of the above Indian characters are provided in English for easier understanding.
k+A=kA

The address locations as provided in FIG. 3 for this example are as follows: 5181+5131=5182. The matrix ratio of this example is taken as 24×24 pixels (units).

Next, the second key depression produces the vowel sign. The results of this example are depicted in FIG. 5. As seen from FIG. 5, the vowel sign is placed next to the consonant, the necessary scaling of the second character will be handled by the layout management tasks. Layout management tasks stored in the database member (4) provide the scaling of data for formation of resultant character with fused character modifiers. Scaling of character and character-modifier is performed by scaling few columns of character matrix and few columns of a character-modifier matrix, this scaling done according data available in the layout management tasks and according to the type of character and modifier combination. After the scaling, the merging of the scaled character and character-modifier to form a resultant character with fried character modifiers takes place. FIG. 5(c) shows the final resultant character with fused modifier.

In an embodiment of the present invention, the process of merging of individual glyphs to form a single entity reduces the total number of glyphs to nearly 50%. The space adjustment as performed in the present invention is exemplified in the following example. In this example, a word from Kannada language is chosen to show the space adjustment and hyphenation.

### EXAMPLE 2

The user selects the steps for the formation of a series of characters sequentially. The processor invokes the layout management task, which determine the spacing between any two resultant characters along with their fused modifiers. The layout management tasks also determine the spacing within each individual character, wherever applicable (especially for Indian languages).

Finally, after the resultant character is formed along with the merged modifier, the same is displayed on the display member of the system of the present invention.

[image]

An example of character formation and display in Chinese language by using the method and system of the present invention is exemplified in the following example.

### EXAMPLE 3

This example is to illustrate the merging process used in Chinese Language. The original character is depicted as (i) and the character after the process of merging is depicted as (ii):

[image]

Advantages

1. By adopting the system of the present invention a sufficient code space to store all the characters, combinations, numerals, grammar symbols, musical symbols, vedic (Indian scriptures) symbols and rarely used letters is achieved.

2. The system of the present invention allocates some extra address locations for each of the languages for future extension.

3. The characters that form a letter together are welded to each other to form a “Whole-character” ensuring that there is no distortion or disconnection of the language text.

4. The combination of characters and character-modifiers are converted into Whole-characters due to which editing of the language text will be easier, as with single back stroke an entire letter can be deleted thereby reducing the editing time.

5. The system of the present invention is designed for multi-lingual pages.

6. The characters displayed using the present invention is vividly visible and has crystal clear readability.

7. Each of the Indian languages does not require a separate font, a single font is sufficient for languages like Indian languages.

8. The system of the present invention can handle all the nuances of all languages based on the input key sequence.

Although the above description may contain specific details, they should not be construed as limiting the claims in any manner. Other configurations of the described embodiments of the invention are part of the scope of the invention. For example, in the present invention, the inventors have used formation of characters and sequence of formed characters to explain the embodiments of the present invention. The subject matter of the present invention is explained by using the alphabets of Kannada (An Indian language). Accordingly, the present invention should not be construed as restricting the rendering of this language alone. The present invention can equally be applied to other languages that form part of Unicode standards. However, other languages, both national and international languages that are UNICODE compatible can very well used.

We claim:

1. A method for rendering multi-lingual characters from a combination of pixels, said method comprising the steps of;
(a) selecting a language from a plurality of languages and prompting a menu of its character set along with modifiers in a user-friendly mode, by means of an input member, said languages stored in a database member,
(b) choosing a character and/or character modifier to be displayed from said selected language from said database member,
(c) fetching an appropriate address of the address location for said character and/or character modifier by mapping from said database member, said address location comprising corresponding character and/or character modifier profile generating executables,
(d) shifting the address of the selected address location to a memory member,
(e) securing the corresponding character and/or character modifier profile generating executables from said address location, into the memory member, by a processor,
(f) generating a pixel sequence, which is associated with the shape of the character and/or character modifier and storing the same in the memory,
(g) invoking the layout management tasks corresponding to the resultant character and/or character modifier from the database,
(h) executing layout management tasks and displaying the resultant character along with the fused modifier, wherever applicable, and
(i) displaying series of resultant characters along with fused modifiers by repeating the aforesaid steps.

2. The method according to claim 1, wherein the selected language is a Unicode compatible language.

3. The method according to claim 1, wherein the language and character set menu is selected either individually or by way of scrolling.

4. The method according to claim 1, wherein the generating of pixel sequence having a desired character width and height, said method comprising the steps of:
(a) reading display resolution from environment settings,
(b) picking up appropriate character matrix ratio for the selected display unit,
(c) initializing a character positioning counter with an initial value of “1”, where “1” is the left-most coordinate of the selected display unit,
(d) initializing the pixel column counter with “0”,
(e) initializing the pixel row counter with “0”,
(f) reading the row and column values iteratively and plotting appropriate pixel to form a pixelized character matrix till the terminal row and column counters equal to “n”, and incrementing the value of pixel column and row counters by 1, and
(g) incrementing the character positioning counter after the formation of a single character and/or modifier by a pre-determined value and generating the final form of character derived from pixel matrix.

5. The method according to claim 1, wherein said layout managing task comprising the steps of:
(a) scaling the height and width of the character and character modifier as per dimensions and dots per inch of display,
(b) fusing or merging the scaled character with the scaled character modifier at the points of scaling, to form the resultant character along with the fused modifier, and
(c) determining spacing between any two resultant characters and spacing within each individual character, wherever applicable.

6. A system for rendering multi-lingual characters from a combination of pixels, said method comprising the steps of;
(a) an input member for selecting a language from a plurality of languages and prompting a menu of its character set along with modifiers in a user-friendly mode,
(b) a database member to store languages, address locations having character and/or character modifier profile generating executables and layout management tasks,
(c) a processor for choosing a character and/or character modifier to be displayed from said selected language from said database member,
(d) said processor to fetch an appropriate address of the address location for said character and/or character modifier by mapping from said database member, said address location comprising corresponding character and/or character modifier profile generating executables,
(e) said processor disposed to shift the address of the selected address location to a memory member,
(f) said processor also disposed to secure the corresponding character and/or character modifier profile generating executables from said address location, into the memory member,
(g) said processor further disposed to generate a pixel sequence, which is associated with the shape of the character and/or character modifier and to store the same in the memory,
(h) said processor disposed to invoke the layout management tasks corresponding to the resultant character and/or character modifier from the database member,
(i) said processor executes layout management tasks and displays the resultant character along with the fused modifier, wherever applicable, and
(j) a display member to display a series of resultant characters along with fused modifiers.

7. The system according to claim 6, wherein the input member is a keyboard, a touch screen or a stylus input from a PC/Server, keypad input or stylus input from a PDA, keypad input or a stylus input from a cellular phone.

8. The system according to claim 7, wherein the user-friendly mode is a menu-based deck of characters and modifiers.

9. The system according to claim 6, wherein the display unit is selected from LCD, PDA and VDU.
